(19) United States
(12) Patent Application Publication
(10) Pub. No.: US 2008/0150851 A1
(43) Pub. Date: Jun. 26, 2008

(54) DISPLAY APPARATUS

(75) Inventors: Kazutada Takaira, Koushi-shi (JP); Takuya Sakamoto, Koushi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/961,322

(22) Filed: Dec. 20, 2007

(30) Foreign Application Priority Data
Dec. 25, 2006 (JP) 2006-347596

(51) Int. Cl. G09G 3/34

(52) U.S. Cl. 345/84

(57) ABSTRACT

The display apparatus includes a display panel for displaying thereon an image, a middle frame on which the display panel has been mounted, a rear frame in which the middle frame is arranged inside of the rear frame, and a front frame in which an opening portion for exposing a display plane 2a of the display panel is provided and which has a connection portion on a plane thereof located substantially parallel to the display plane of the display panel, while the connection portion projects to an opposite plane side with respect to the display plane, and is connected to the middle frame.

This application claims priority from Japanese Patent Application No. 2006-347596 filed on Dec. 25, 2006, the entire subject matter of which is incorporated herein by reference.

### BACKGROUND OF THE INVENTION

1. Field of the Invention

The present invention is related to a display apparatus equipped with a frame having a fixing structure with a shock resistant characteristic.

2. Description of the Related Art

Among related display apparatuses, for instance, in a display apparatus equipped with liquid crystal, a light conducting plate for conducting light to a display panel has been arranged on another plane of the display panel, which is located opposite to the display plane of the display panel; and a light source such as a light emitting diode (LED) has been arranged on a side plane of the light conducting plate. The light emitted from the light source is propagated within the light conducting plate, and then, the propagated light is diffused by a diffusing pattern provided within the light conducting plate, so that the light is derived to the display panel.

Furthermore, in the above-described display apparatus, a middle frame for supporting thereon the light conducting plate has been arranged; a rear frame for supporting movement of the light conducting plate along a horizontal direction has been arranged on a plane of the rear frame, which is located opposite to such a plane where the display panel has been arranged; and also, a front frame having an opening portion and for supporting both the display panel and the middle frame has been arranged on the display plane of the display panel.

In the related display apparatuses, while upper frame claws have been formed on upper frames and lower frame slots have been formed in lower frames at such positions located in correspondence with the upper frame claws, the upper frame claws are engaged with the lower frame slots in order that the upper frames may be fixed with the lower frames (refer to, for instance, JP-A-7-199180).

Also, in another related display apparatus, while 2 pieces of projection portions of a heat radiating plate are provided on right and left portions of the heat radiating plate, the heat radiating plate is arranged in such a manner that the respective 2 projection portions of the heat radiating plate may be entered to stepped portions of a forming frame, and also, a projection portion of the forming frame may be entered into a concave portion of the heat radiating plate. Then, a rear plate is mounted on this arranged heat radiating plate so as to be mounted on the forming frame. In this case, the projection portion of the forming frame is set to be slightly projected from a hole of the rear plate, which has been formed in a portion in the vicinity of a bent portion of the rear plate, and thus, the projection portion of the heat radiating plate is set up to an inner bent side of the bent portion of the rear plate, namely, is set up to the same plane as the side plate of the forming frame (refer to, for example, JP-A-11-133393).

In the related technique described in JP-A-7-199180, in such a case that the display apparatus receives vibrations and shock from such a plane direction parallel to the display plane of the display panel, the vibrations and the shock are absorbed by the side plane of the upper frame (front frame). As a result, the upper frame is opened, so that the engagement established between the upper frame claws (fixing claws) and the lower frame slots (claw receiving portions) is broken.

Also, in the related display apparatus recited in JP-A-11-133393, the projection portions formed on the forming frame (middle frame) are employed in order to restrict the position of the heat radiating plate. However, JP-A-11-133393 nether discloses, nor teaches a fixing structure between the front frame and the rear frame.

### SUMMARY OF THE INVENTION

The present invention has been made to solve the above-described problems, and therefore, has an object to provide such a display apparatus equipped with a fixing structure having a shock resistant characteristic, namely, in the display apparatus of the present invention, even when vibrations and shock are received from a plane direction parallel to a display plane of a display panel, a fixing condition established between a front frame and a rear frame is not broken.

A display apparatus, according to the present invention, is featured by providing: a rear frame having a claw receiving portion on a side plane of the rear frame in which a middle frame is arranged inside the rear frame and the middle frame has mounted thereon a display panel for displaying thereon an image; and a front frame made of a metal material, in which an opening portion for exposing the display plane of the display panel is provided, and which has a connection portion on a plane thereof located substantially parallel to the display plane of the display panel, and also has a fixing claw on a side plane thereof, which is fixed with the craw receiving portion of the rear frame, the connection portion projecting to an opposite side with respect to the display plane, being connected to the middle frame, and restricting movement along upper/lower directions and right/left directions.

In accordance with the display apparatus of the present invention, it is possible to achieve such a display apparatus equipped with the fixing structure having the shock resistant characteristic, by which even when vibrations and shock are received from the plane direction parallel to the display plane of the display panel, the fixing condition established between the front frame and the rear frame is not broken.

### BRIEF DESCRIPTION OF THE DRAWINGS

FIG. 1 is an exploded perspective view for showing a display apparatus according to an embodiment 1 of the present invention;

FIG. 2 is a plan view for indicating the display apparatus which has been accomplished by coupling all of structural members with each other shown in the exploded view of FIG. 1;

FIG. 3 is a sectional view for representing the display apparatus, taken along a line A-A in FIG. 2;

FIG. 4 is a sectional view for representing the display apparatus, taken along a line B-B in FIG. 2;

FIG. 5 is a diagram for explaining another frame fixing structure employed in the display apparatus according to the embodiment 1 of the present invention;

FIG. 6 is a diagram for explaining another frame fixing structure employed in the display apparatus according to the embodiment 1 of the present invention;

FIG. 7 is a diagram for explaining another frame fixing structure employed in the display apparatus according to the embodiment 1 of the present invention;

FIG. 8 is a diagram for explaining another frame fixing structure employed in the display apparatus according to the embodiment 1 of the present invention;

FIG. 9 is a diagram for describing a connection method of connecting a rear frame with a front frame in a display apparatus according to an embodiment 2 of the present invention;

FIG. 10 is a diagram for describing another connection method of connecting a rear frame with a front frame in the display apparatus according to the embodiment 2 of the present invention;

FIG. 11 is a diagram for describing a connection method of connecting a rear frame, a middle frame, and a front frame with each other in the display apparatus according to the embodiment 2 of the present invention;

FIG. 12 is a diagram for describing another connection method of connecting a rear frame, a middle frame, and a front frame with each other in the display apparatus according to the embodiment 2 of the present invention;

FIG. 13 is a diagram for describing a connection method of connecting a middle frame with a front frame in a display apparatus according to an embodiment 3 of the present invention; and

FIG. 14 is a diagram for describing another connection method of connecting a rear frame with a front frame in the display apparatus according to the embodiment 3 of the present invention.

### DETAILED DESCRIPTION OF THE PREFERRED EMBODIMENTS

Various modes to which the present invention can be applied will be described as follows: That is, the below-mentioned descriptions are merely provided in order to explain embodiments of the present invention, and therefore, the present invention is not limited only the below-mentioned embodiments. In order to clarify the explanations, the below-mentioned descriptions have been properly omitted and simplified. Also, ordinarily skilled engineers may readily modify, change, and/or add respective elements employed in the below-mentioned embodiments within the technical scope of the present invention.

### Embodiment 1

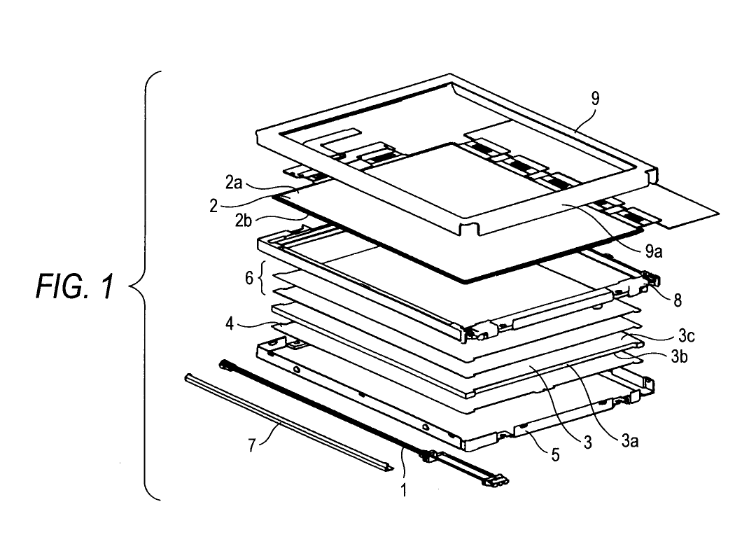

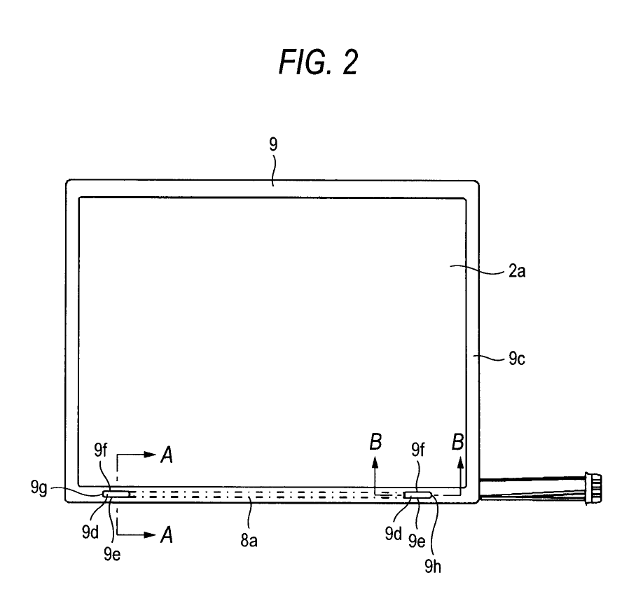

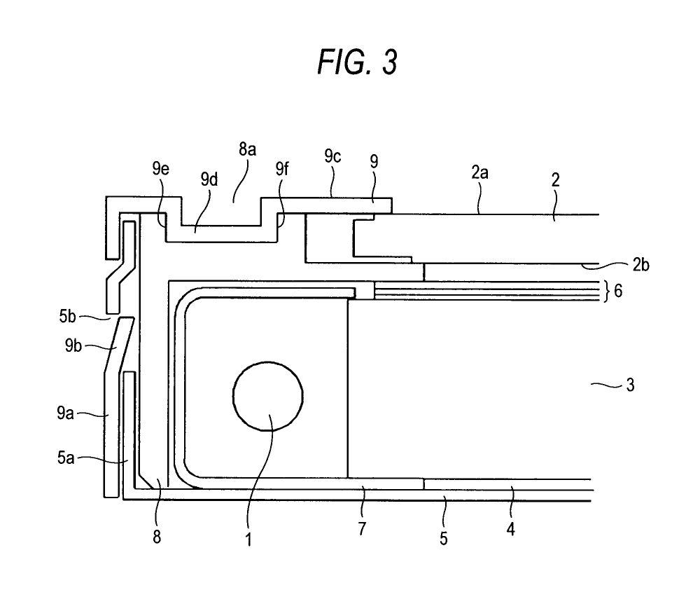

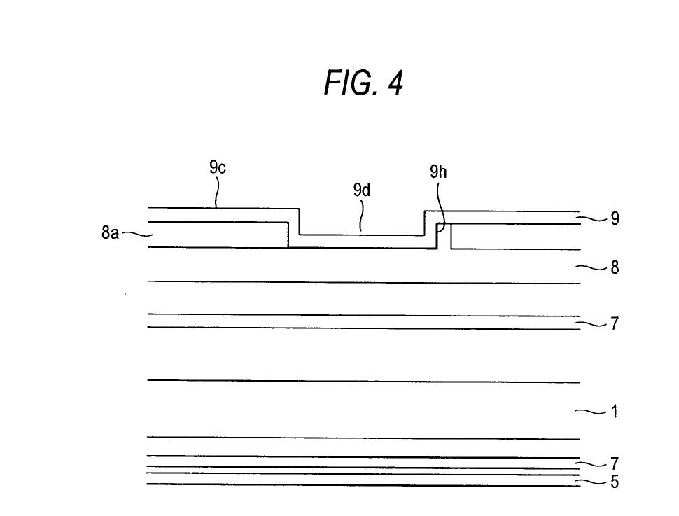

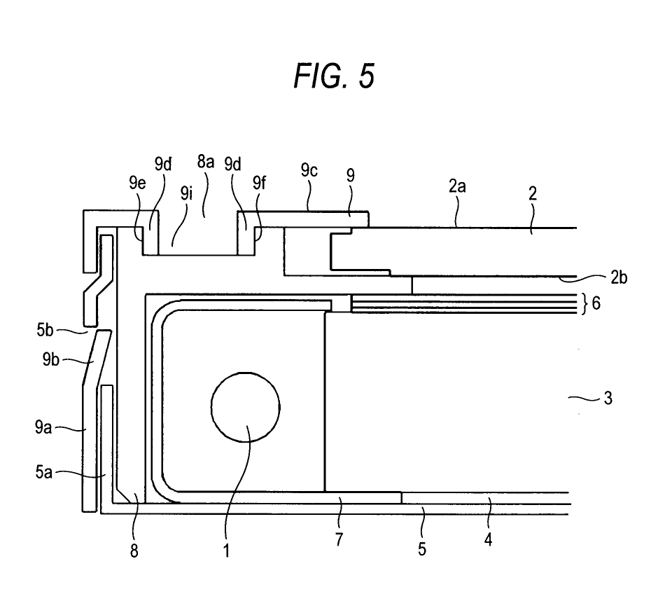

FIG. 1 is an exploded perspective view for showing a display apparatus according to an embodiment 1 of the present invention. FIG. 2 is a plane view of the display apparatus which has been completed by coupling all of structural components with each other shown in the exploded perspective view of FIG. 1. FIG. 3 is a sectional view for indicating a portion of the display apparatus, taken along a line A-A of FIG. 2. FIG. 4 is a sectional view for showing a portion of the display apparatus, taken along a line B-B of FIG. 2. FIG. 5 to FIG. 8 are explanatory diagrams for explaining other frame fixing structures provided in the embodiment 1 of the present invention.

In FIG. 1 to FIG. 8, a light source 1 such as a cold cathode fluorescent lamp (CCFL) is arranged on the side of a side plane of a light conducting plate 3 in order that light emitted from the light source 1 is conducted to a display plane 2a of a display panel 2 and the conducted light is diffused. Alight scattering portion (not shown) has been formed on an opposite light emerging plane 3b (in this case, opposite light emerging plane 3b implies lower plane of light conducting plate 3 with respect to paper plane) of the light conducting plate 3, while the light scattering portion is employed in order that a propagation direction of the light is scattered, and then, the scattered light is conducted to a light emerging plane 3c thereof (in this case, light emerging plane 3c implies upper plane of light conducting plate 3 with respect to paper plane). This light scattering portion may function as means for deriving light from the light conducting plate 3 by disturbing a total reflecting condition of the light which is propagated within the light conducting plate 3. Furthermore, concretely speaking, as the above-described means for scattering the light, there are the below-mentioned methods: a method for printing a dot pattern on the opposite light emerging plane 3b of the light conducting plate 3; a method for making the opposite light emerging plane 3b as a coarse plane; a method for forming concaves/convexes on the opposite light emerging plane 3b, while the concaves/convexes such as very small spherical planes and a prism may change a propagation direction of light; and so on.

The light conducting plate 3 is made of either a resin plate or a glass board, namely has such a function that light can penetrate therethrough, while the resin plate is selected from polyethyleneterephthalate (PET), polymethyl methacrylate (PMMA), polycarbonate (PC), cycloolefin series, or the like. In particular, since the polycarbonate resin and the cycloolefin-series resin are used, the dimensional change in the light conducting plate 3 due to a change in temperatures may be reduced. As a result, since the light conducting plate 3 may be used in a wider temperature range, resulting in a specific merit.

While a reflection seat 4 has been provided on the side of the opposite light emerging plane 3b of the light conducting plate 3 in order to effectively reflect thereon light, both the light conducting plate 3 and the reflection seat 4 have been arranged inside a rear frame 5 which is made of a metal, a resin, or the like. As a material of the reflection seat 4, this seat material is made of metals such as silver, aluminium, and stainless steel, or a foaming PET film (white color PET film) containing a fluorescent agent. More specifically, the white color PET film has such a feature that scratches made of the reflection plane thereof can be hardly found out, and the white color PET film can be readily handled. Accordingly, it is preferable to employ the white color PET film as the reflection seat 4.

Also, an optical seat group 6 is arranged on the side of the light emerging plane 3c of the light conducting plate 3, while the optical seat group 6 is made of plural sheets of optical seats capable of effectively utilizing light.

It should be understood that the optical seat group 6 has such a structure that lens seats are sandwiched by diffusing seats. Also, in the case that an improvement in luminance is required, the plural sheets of lens seats may be alternatively combined with each other by considering prism directions of seats formed on surfaces thereof. Also, when a diffusion characteristic of a diffusing seat is improved, 2 sheets, or more sheets of diffusing seats may be alternatively employed. Furthermore, depending upon a light distribution characteristic of a lens seat, only 1 sheet of such a lens seat may be employed, or the lens seat may not be employed. In addition, a lens seat may be alternatively combined with a polarizing reflection seat. Further, any one of the above-described lens seat and polarizing reflection seat may not be alternatively employed. Thus, it is preferable to optimize the optical seat group 6 by considering the required luminance, the necessary light distribution characteristic, and the like.

Also, a lamp reflector 7 is arranged on the side of the side plane 3a of the light conducting plate 3 in such a manner that the lamp reflector 7 has an opening portion on the side of the side plane 3a of the light conducting plate 3 and covers the light source 1.

Also, the light source 1, the light conducting plate 3, the reflection seat 4, the optical seat group 6, and the lamp reflector 7 have been arranged on an upper plane (in this case, upper plane implies upper plane of rear frame 5 with respect to paper plane), and then, have been sandwiched by the rear frame 5 and a middle frame 8 made of either a metal or a resin. Moreover, the light source 1, display panel 2, the light conducting plate 3, the reflection seat 4, the optical seat group 6, the lamp reflector 7, and the middle frame 8 have been sandwiched by the rear frame 5 and a front frame 9 having an opening portion. It should also be understood that although the light source 1 has been provided only on one side plane 3a of the light conducting plate 3 in FIG. 1, the present invention is not limited only to this structure. Alternatively, light sources and light source boards may be provided on two, or more pieces of side planes of the light conducting plate 3. Furthermore, as the light source 1, such a point light source as a light emitting diode (LED) and a laser diode may be alternatively employed other than the above-described CCFL.

The front frame 9 having the opening portion contains fixing claws 9b formed on plural portions of a side plane 9a of this front frame 9 by performing a press treatment. The front frame 9 has been fixed on the rear frame 5 and claw receiving portions 5b of the side plane 5a of the rear frame 5 by bending and caulking the fixing claws 9b.

As indicated in FIG. 1 to FIG. 4, in the embodiment 1, the front frame 9 made of such a metal material as aluminium, stainless steel, iron, or the like has connection portions 9d on a plane 9c of the front frame 9, which is located parallel to the display plane 2a of the display panel 2. The connection portions 9d are projected to the opposite side (opposite light display plane 2b) with respect to the display plane 2a, and are engaged with connection portions 8a formed on the middle frame 8. Also, in this front frame 9, contact planes 9e, 9f, 9g, and 9h have been provided on the front frame 9, which are contacted to the connection portions 8a of the middle frame 8 and the connection portions 9d of the front frame 9. Alternatively, the connection portions 8a formed on the middle frame 8 may be made as holes, through holes, or grooves which are not penetrated therethrough.

It should also be noted that in the embodiment 1, while the connection portions 9d of the front frame 9 have been provided one by one on both end portions of the connection portion 8a formed along one edge of the middle frame 8, the contact plane 9e and/or the contact plane 9f may absorb vibrations and shock along an upper/lower direction (in this case, upper/lower direction implies upper direction and lower direction of front frame 9 shown in FIG. 2 with respect to paper plane), whereas the contact plane 9g and/or the contact plane 9h may absorb vibrations and shock along a right/left direction (in this case, right/left direction implies right direction and left direction of front frame 9 shown in FIG. 2 with respect to paper plane).

Since these contact planes 9e, 9f, 9g, and 9h are provided, even when the vibrations and the shock are received along the plane direction parallel to the display plane 2a of the display panel 2, these vibrations and shock can be distributed to be received by the side plane 9a of the front frame 9, and also the contact planes thereof 9e, 9f, 9g, 9h. As a result, it is possible to suppress that the fixed condition established between the front frame 9 and the rear frame 5 is released.

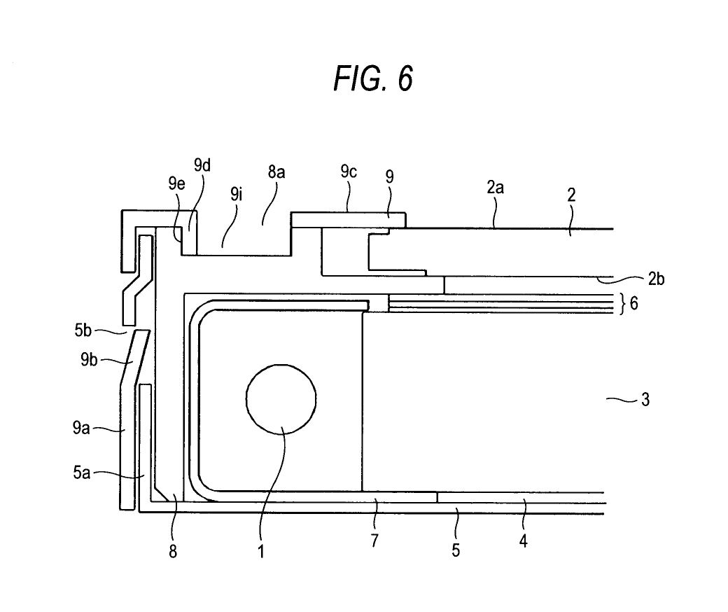

As shown in FIG. 5 and FIG. 6, even in such a case that a penetration portion 9i is provided in the connection portion 9d of the front frame 9, the contact plane 9e and/or the contact plane 9f, and the contact plane 9g and/or the contact plane 9h can be provided, in which the contact portions 8a of the middle frame 8 and the contact portions 9d of the front frame 9 are contacted to each other. As a result, the side plane 9a of the front frame 9, the contact plane 9e and/or the contact plane 9f, and also, the contact plane 9g and/or the contact plane 9h can distribute the variations and the shock to absorb these distributed vibrations and shock.

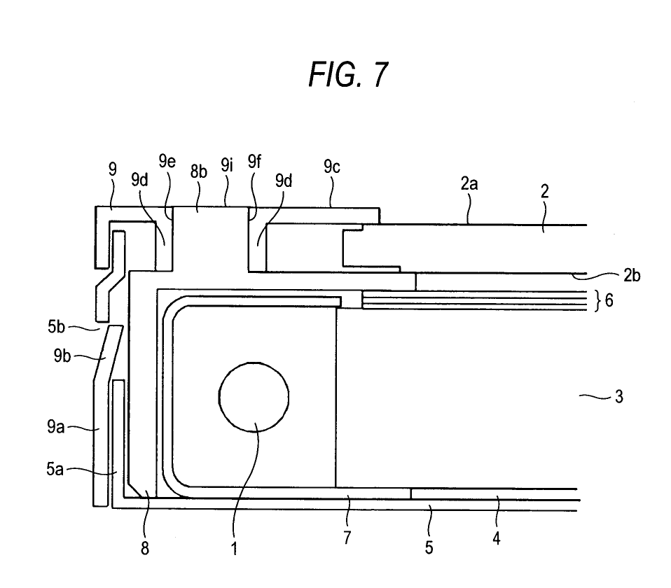

As indicated in FIG. 7, even in such a case that a projection portion 8b is provided on the middle frame 8 and the projection portion 8b is engaged with the penetration portion 9i of the front frame 9, a similar effect may be achieved by the contact planes 9e, 9f, 9g and 9h, where the projection portion 8b of the middle frame 8 is contacted to the connection portion of the front frame 9.

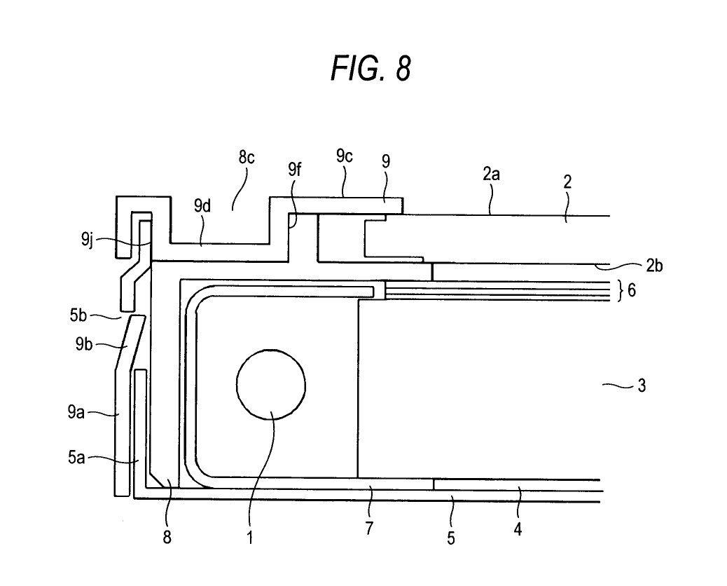

Next, as shown in FIG. 8, a contact plane 9f and another contact plane 9j have been provided on such a plane 9c of the front frame 9, which is located substantially parallel to the display plane 2a of the display panel 2, while having a connection portion 9d which is projected to an opposite-sided plane (opposite display plane 2b) with respect to the display plane 2a, and is engaged with a notch portion 8c formed in the middle frame 8. The contact plane 9f is contacted to the middle frame 8. The contact plane 9f is contacted to the side plane 5a of the rear frame 5. A similar effect may be achieved even by the contact planes 9f and 9j.

The embodiment 1 has described such a case that due to an easy assembling work, the connection portions 9d of the front frame 9 have been provided on both the end portions of the connection portion 8a provided along one edge of the middle frame 8 respectively, and have been contacted with the contact planes 9e, 9f, 9g, and 9h. Alternatively, since the connection portion 9d is formed in such a manner that all planes of this connection portions 9d are contacted to the connection portion 8a of the middle frame 8, the connection portion 9d may be provided only at one portion on the plane 9c of the front frame 9, which is located substantially parallel to the display plane 2a of the display panel 2. Accordingly, the structure of the front frame 9 may be made simpler.

Alternatively, the connection portions 9d may be provided on four edge planes 9c of the front frame 9, which are located substantially parallel to the display plane 2a of the display panel 2. As a result, it is possible to more firmly suppress that the fixed condition established between the front frame 9 and the rear frame 5 is released.

Also, the embodiment 1 has described such a case that the connection portions 9d of the front frame 9 have been formed on 2 portions of one edge of the front frame 9. Alternatively, positions, total numbers, and shapes may be determined in an arbitrary manner by considering the entire structure of the display apparatus in order that it is possible to suppress that the fixed condition established between the front frame 9 and the rear frame 5 is released.

### Embodiment 2

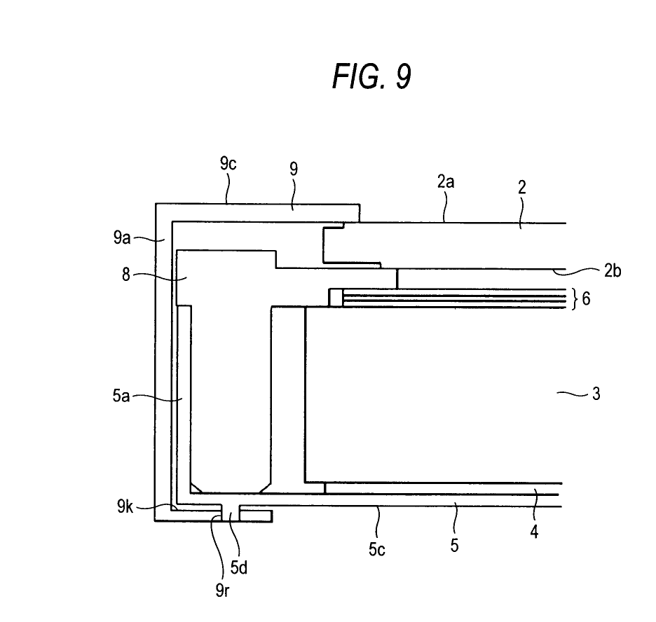

Referring now to FIG. 9 to FIG. 12, a description is made of an embodiment 2 of the present invention. In this embodiment 2, structures as to a light source 1, a display panel 2, a light conducting plate 3, a reflection seat 4, an optical seat group 6, and a lamp reflector 7 are similar to those of the above-described embodiment 1, and therefore, the same reference numerals will be employed as those for denoting these similar structures, and explanations thereof will be omitted in the embodiment 2. In the below-mentioned description, an explanation is made of, especially, shapes as to a rear frame 5, a middle frame 8, and a front frame 9 with reference to FIG. 9 to FIG. 12. It should be understood that the same reference numerals shown in FIG. 1 to FIG. 8 will be employed as those for denoting the same structural portions indicated in FIG. 9 to FIG. 12.

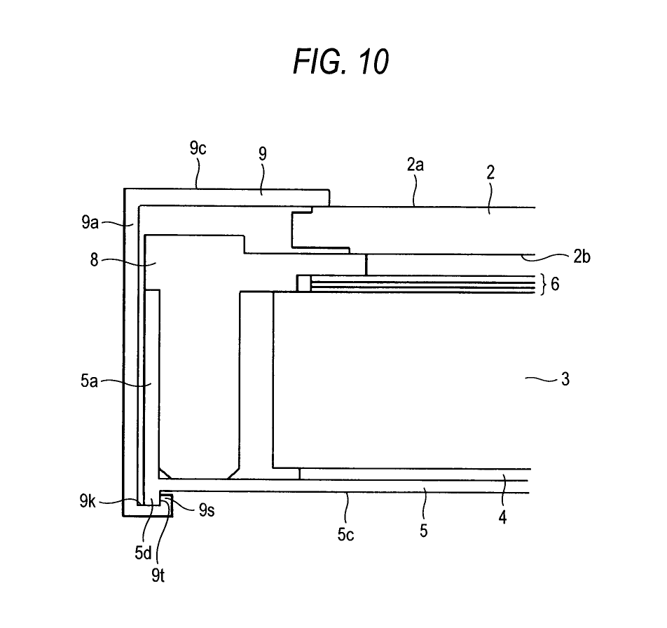

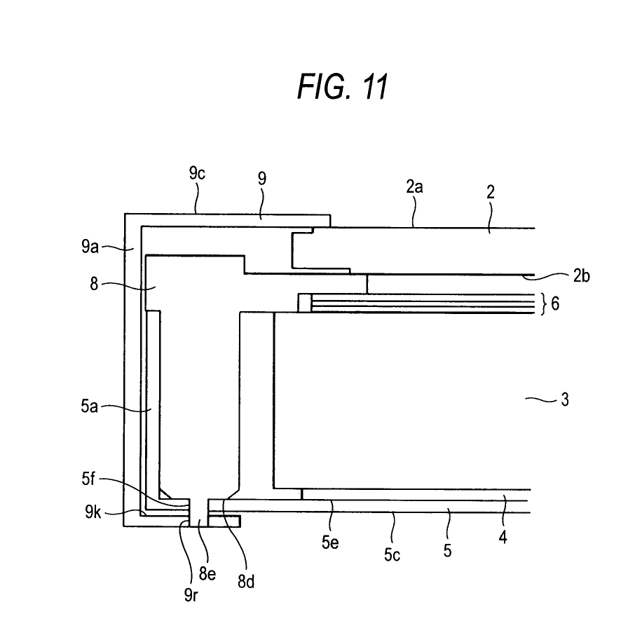

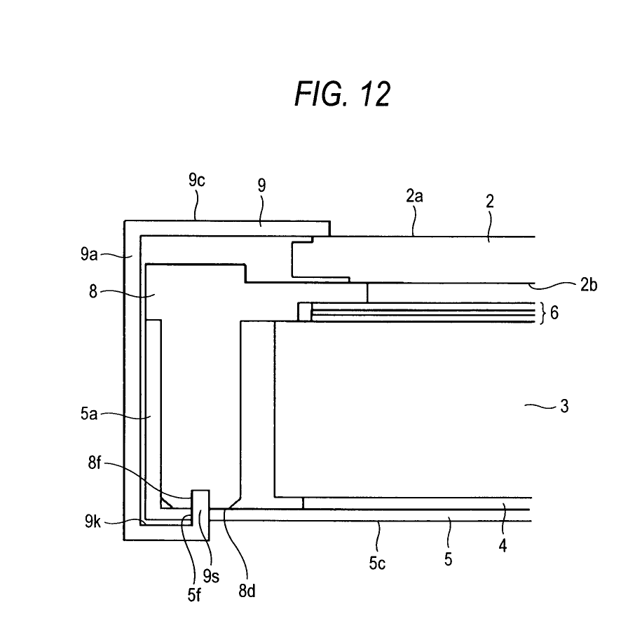

FIG. 9 and FIG. 10 are diagrams for explaining a connection method of connecting the rear frame 5 to the front frame 9 in the embodiment 2 of the present invention. FIG. 11 and FIG. 12 are diagrams for explaining a method of connecting the rear frame 5, the middle frame 8, and the front frame 9 to each other in the embodiment 2.

In FIG. 9, in the rear frame 5, while a projection portion 5d projected outwardly has been formed on an opposite plane 5c of this rear frame 5, which is located opposite to the display plane 2a of the display panel 2, the projection portion 5d has been engaged with a hole 9r. The hole 9r corresponds to a connection portion provided on a plane 9k of the front frame 9, which is superimposed with a plane 5c of the rear frame 5.

Since such a structure of the display apparatus of the embodiment 2 is employed, even when the structure receives vibrations and shock from a plane direction parallel to the display plane 2a of the display panel 2, it is possible to suppress that a fixed condition established between the front frame 9 and the rear frame 5 is released.

Also, as indicated in FIG. 10, a projection portion 5d of the rear frame 5 is engaged with another projection portion 9s corresponding to a connection portion which has been provided to be projected to the side of a plane 5c of the rear frame 5, and a contact plane 9t has been provided on a plane 9k of the front frame 9. As a result, a similar effect to that of the above-described FIG. 9 may be achieved.

It should also be noted that if the connection methods for connecting the rear frame 5 to the front frame 9 indicated in FIG. 9 and FIG. 10 are provided on 2 edges which are located opposite to each other, then a more effective suppression may be achieved.

Next, as shown in FIG. 11, in the middle frame 8, while a projection portion 8e projected outwardly has been formed on an opposite plane 8d of this middle frame 8, which is located opposite to the display plane 2a of the display panel 2, the projection portion 8e has been engaged with a through hole 5f and a hole 9r. The through hole 5f has been formed on a plane 5e of the rear frame 5 which is superimposed with the plane 8d of the middle frame 8. The hole 9r has been provided on a plane 9k of the front frame 9, which is superimposed with a plane 5c of the rear frame 5.

Since such a structure of the display apparatus of the embodiment 2 is employed, even when the structure receives vibrations and shock from a plane direction parallel to the display plane 2a of the display panel 2, it is possible to more firmly suppress that a fixed condition established between the front frame 9 and the rear frame 5 is released. It should also be understood that in FIG. 9 and FIG. 11, the hole 9r of the front frame 9 has penetrated through the plane 9k thereof. Alternatively, if either the projection portion 5d of the rear frame 5 or the projection portion 8e of the middle frame 8 may be engaged with the hole 9r, even when this hole 9r need not penetrate through the plane 9k, there is no problem.

Also, as indicated in FIG. 12, a projection portion 9s corresponding to a connection portion which has been provided on the plane 9k of the front frame 9 and is projected to the side of a plane 5c of the rear frame 5, has been engaged with a hole 8f formed in a plane 8d of the middle frame 8 and the through hole 5f formed in the plane 5e of the rear frame 5. As a result, a similar effect to the above-described effect may be achieved. It should also be noted that in FIG. 12, although the projection portion 9s of the front frame 9 has been engaged with the hole 8f formed in the plane 8d of the middle frame 8, even when this projection portion 9s is engaged with the through hole 5f of the rear frame 5, there is no problem. Other structures of the embodiment 2 are similar to those of the above-described embodiment 1.

### Embodiment 3

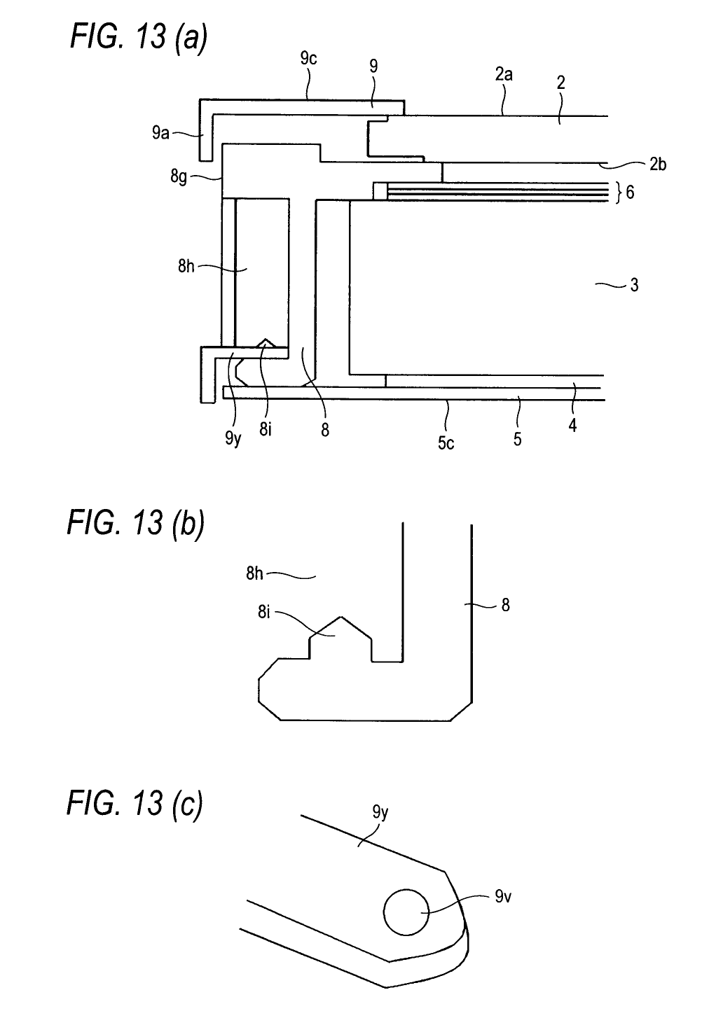

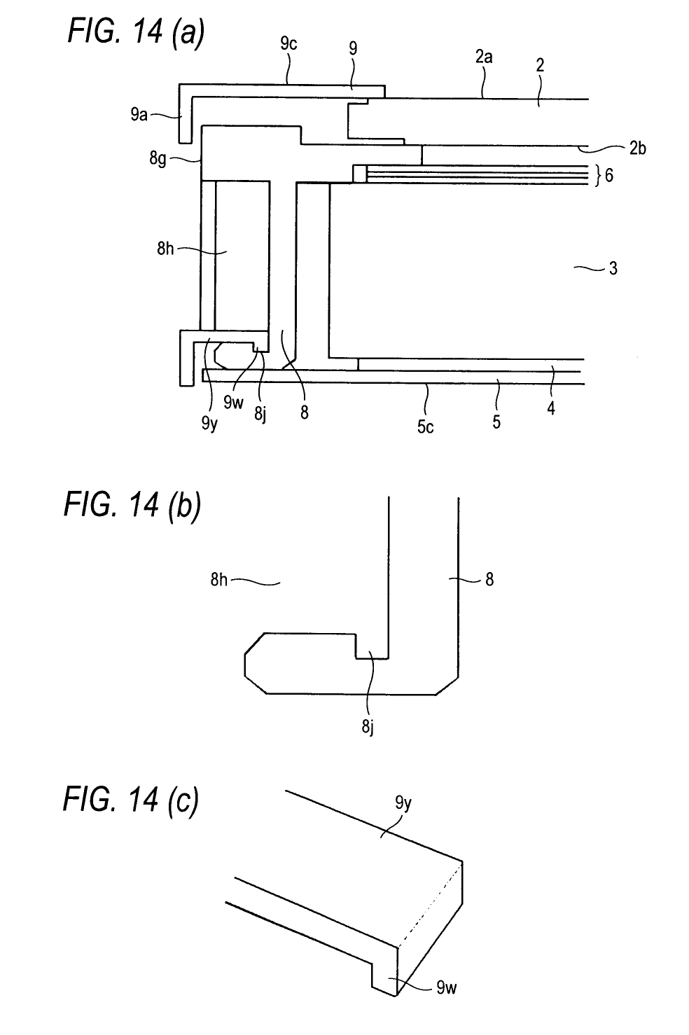

Referring now to FIG. 13 and FIG. 14, a description is made of an embodiment 3 of the present invention. In this embodiment 3, structures as to a light source 1, a display panel 2, a light conducting plate 3, a reflection seat 4, a rear frame 5, an optical seat group 6, and a lamp reflector 7 are similar to those of the above-described embodiment 1, or the embodiment 2, and therefore, the same reference numerals will be employed as those for denoting these similar structures, and explanations thereof will be omitted in the embodiment 3. In the below-mentioned description, an explanation is made of, especially, shapes as to, a middle frame 8 and a front frame 9 with reference to FIG. 13 and FIG. 14. It should be understood that the same reference numerals shown in FIG. 1 to FIG. 12 will be employed as those for denoting the same structural portions indicated in FIG. 13 and FIG. 14.

FIG. 13(a) and FIG. 14(a) are diagrams for explaining a connection method of connecting the middle frame 8 to the front frame 9 in the embodiment 3 of the present invention. FIG. 13(b) and FIG. 14(b) are enlarged views for explaining a connection portion of the middle frame 8 in the embodiment 3 of the present invention. FIG. 13(c) and FIG. 14(c) are enlarged views for describing a bent portion of the front frame 9 in the embodiment 3 of the present invention.

In FIG. 13 and FIG. 14, while a bent portion 9y has been provided on a side plane 9a of the front frame 9, the bent portion 9y has been inwardly bent, and has either a hole 9v or a projection portion 9w. In a notch portion 8h formed in a side plane 8g of the middle frame 8, which is located opposite to the side plane 9a of the front frame 9, either the hole 9v or the projection portion 9w of the front frame 9 has been connected to either a convex portion 8i or a concave portion 8j, which corresponds to a connection portion of the middle frame 8. It should be noted that if the hole 9v is connectable to the convex portion 8i, even when the hole 9v need not penetrate through the bent portion 9y, there is no problem.

Since such a structure of the display apparatus of the embodiment 3 is employed, even when the structure receives vibrations and shock from a plane direction parallel to the display plane 2a of the display panel 2, it is possible to suppress that a fixed condition established between the front frame 9 and the rear frame 5 is released.

It should also be understood that in FIG. 13 and FIG. 14, there is only one connection portion between the middle frame 8 and the front frame 9. Alternatively, positions, total numbers, and shapes may be determined in an arbitrary manner by considering the entire structure of the display apparatus in order that it is possible to suppress that the fixed condition established between the front frame 9 and the rear frame 5 is released.

While the present invention has been described with respect to the embodiments 1 to 3, the respective embodiments may be alternatively employed by combining these embodiments with each other in a proper manner.

It should also be understood that although the plate-shaped light conducting members have been employed as the light conducting plate 3 in the above-described embodiments 1 to 3, the present invention is not limited only to these plate-shaped light conducting members, but may be modified as follows: That is, for instance, the light conducting plate 3 may be alternatively made in a wedge shape whose thickness becomes thinner, the further this light conducting plate 3 having the wedge shape is separated from the light source 1. As a result, light entered to the light conducting plate 3 having the wedge shape may be effectively derived therefrom, so that the derived light may be effectively conducted to the light emerging plane 3c.

What is claimed is:

1. A display apparatus comprising:
a display panel for displaying thereon an image;
a middle frame on which the display panel has been mounted;
a rear frame having a claw receiving portion on a side plane thereof, the middle frame being arranged inside of the rear frame; and
a front frame made of a metal material including:
an opening portion for exposing the display plane of the display panel;
a connection portion on a plane thereof located substantially parallel to the display plane of the display panel, the connection portion projecting to an opposite plane side with respect to the display plane, being connected to the middle frame, and restricting movement along upper/lower directions and right/left directions; and
a fixing claw on a side plane thereof, which is fixed with the craw receiving portion of the rear frame.

2. The display apparatus according to claim 1,
wherein the connection portion of the front frame is engaged with a hole formed in the middle frame.

3. The display apparatus according to claim 1,
wherein the connection portion of the front frame is formed on each plane of four sides of the front frame, the four sides of the front frame being located substantially parallel to the display plane of the display panel.

4. A display apparatus comprising:
a display panel for displaying thereon an image;
a middle frame on which the display panel has been mounted;
a rear frame having a claw receiving portion on a side plane thereof, the middle frame being arranged inside of the rear frame; and
a front frame made of a metal material, including:
an opening portion for exposing the display plane of the display panel;
a connection portion on a plane which is superimposed with a plane of the rear frame, which is located opposite to the display plane of the display panel, the connection portion being connected to any one of the middle frame and the rear frame; and
a fixing claw on a side plane thereof, which is fixed with the claw receiving portion of the rear frame.

5. A display apparatus according to claim 4,
wherein the connection portion of the front frame is formed by a hole, and is engaged with a projection portion formed on a plane of the rear frame, which is located opposite to the display plane side of the display panel, and the projection portion is projected outside the opposite plane of the rear frame.

6. A display apparatus comprising:
a display panel for displaying thereon an image;
a front frame including:
an opening portion for exposing the display plane of the display panel is provided; and
a bent portion having any one of a hole and a projection portion is provided on a side plane of the front frame, the bent portion being bent inside of the front frame; and
a middle frame, on which the display panel is mounted, including:
a notch portion formed in a side plane of the middle frame, which is located to the side plane of the front frame; and
a connection portion connected to any one of the hole and the projection portion of the bent portion of the front frame, the connection portion being formed in the notch portion.
